(19) United States
(12) Patent Application Publication
(10) Pub. No.: US 2008/0076110 A1
(43) Pub. Date: Mar. 27, 2008

(54) Method and Apparatus to Facilitate Creative Content Development that Complies with End-Use Technical Specifications

(76) Inventors: James C. Mikol, Riverside, IL (US); Elise B. Garber, Chicago, IL (US); Nancy Flemm, Chicago, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/465,050

(22) Filed: Aug. 16, 2006

(51) Int. Cl. G09B 19/00

(52) U.S. Cl. 434/365; 434/118

(57) ABSTRACT

These various embodiments facilitate the development of creative content in a manner that fosters compliance with technical requirements as correspond to an intended end use of that creative content. This can comprise providing (101) creative content technical specifications as correspond to a plurality of differing end use vehicles and providing (102) a plurality of creative content development tools that are non-integral with respect to one another and wherein at least some of the creative content development tools are each for use during differing creative content development stages. One then provides (103) a digital processing environment and a creative content development process (104) that uses the digital processing environment along with the plurality of creative content development tools in a substantially integrated manner that makes use of the creative content technical specifications to fully facilitate creative freedom while also simultaneously ensuring compliance with end-use technical specifications.

### TECHNICAL FIELD

This invention relates generally to the execution of creative content such as promotional materials.

### BACKGROUND

The development of creative content constitutes a long-standing practice. This can comprise, for example, the development of textually-based, graphically-based, and audibly-based creative content that can vary considerably with respect to relative size, constitution, and so forth. In many cases, the resultant creative content is published, displayed, or otherwise made available to a consuming audience. The nature of this end use can vary greatly as well depending in part upon the specifics of the creative content itself as well as numerous other factors.

Such end uses are typically characterized by a number of corresponding technical specifications. Such specifications can vary both with the nature of the creative content itself as well as limitations and/or opportunities as pertain to the end use media or vehicle. Some illustrative examples in this regard might comprise size requirements, digital storage specifications, color guidelines, spacing and/or other registration requirements, resolution specifications, and so forth. Understanding such requirements (and/or opportunities) can be important. It is possible, for example, for a particular item of creative content to be partially or wholly unusable and/or unsuitable for a particular end use because of a mismatch between the physical characteristics of that creative content and the technical specifications of that particular end use.

In some cases, the creative content developer (which, as used herein, can include both the person or persons who imagine and create the creative content as well as the individuals who effect or facilitate the execution of one or more steps or actions as may be useful or necessary to render the creative content usable for an intended end use) will work repeatedly with a single end use purpose and platform and will therefore, over time, gain a familiarity with the technical specifications of that end use purpose/platform. In other cases, however, the creative content developer may expect to work with a variety of end uses that differ from one another in various ways with respect to their technical specifications. As one example in this regard, a developer of creative content for promotional materials may be tasked to develop a one-page advertisement for a given product. When that advertisement is slated to appear in, say, six different magazines, that developer can be greatly challenged to ensure that their creative content meets the technical specifications as pertain to each such magazine. This does not necessarily require that a single version of the creative content be compatible with a variety of differing end uses, but versions of the creative content as are provided to each end user should be compatible in this regard.

These circumstances present a considerable challenge. There are literally thousands of end use possibilities for such a developer (when one includes paper-based vehicles, broadcast-based vehicles, Internet-based vehicles, and so forth). In addition, the specifications for any of these end uses constitutes a dynamic element in that one or more of the technical specifications is likely to change over time for any number of reasons. These problems are further exacerbated by the fact that, in many creative content development processes, the creative content must use a plurality of creative content development tools that are non-integral with respect to one another and where the end use technical specifications can apply to one or more of these tools. As a result, mere knowledge of the relevant end use technical specifications may be insufficient to ensure compliant use of such information; the developer may further need to understand which technical specifications apply to which of their creative content development tools.

These and other related problems present a real and troubling reality for both the developers and publishers of creative content (where “publishers” will be understood to include publishers of various kinds including, without limitation, broadcasters, printers, website hosts, and so forth). Creative efforts can be partially or wholly stymied or frustrated by such issues. Efforts to comply, on the other hand, can consume significant amounts of time and can require an attention to technical detail that may not suit the skill sets of many creative content developers. These concerns can also effectively limit creativity in that a creative content developer who successfully navigates this maze of technical specifications may tend to avoid reaching beyond what works. Such self-imposed limitations can readily lead to an underutilization of the creative possibilities that are genuinely available in a given setting.

As a general result of these and related issues, creative content developers are frustrated; creative content, in turn, suffers. At the same time, the relative time required to develop a given item of creative content increases as does the corresponding relative cost. This, in turn, effectively leads to increasingly expensive creative content deliverables that are themselves less creative than the overall process might otherwise accept. In a nutshell, it is costing more to receive less.

### BRIEF DESCRIPTION OF THE DRAWINGS

The above needs are at least partially met through provision of the method and apparatus to facilitate creative content development that complies with end-use technical specifications described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a flow diagram as configured in accordance with various embodiments of the invention;

FIG. 4 comprises a schematic screen shot as configured in accordance with various embodiments of the invention;

FIG. 5 comprises a schematic screen shot as configured in accordance with various embodiments of the invention;

FIG. 6 comprises a schematic screen shot as configured in accordance with various embodiments of the invention;

FIG. 7 comprises a schematic screen shot as configured in accordance with various embodiments of the invention;

FIG. 8 comprises a schematic screen shot as configured in accordance with various embodiments of the invention;

FIG. 9 comprises a schematic screen shot as configured in accordance with various embodiments of the invention;

FIG. 10 comprises a flow diagram as configured in accordance with various embodiments of the invention;

FIG. 11 comprises a schematic screen shot as configured in accordance with various embodiments of the invention;

FIG. 12 comprises a schematic screen shot detail as configured in accordance with various embodiments of the invention;

FIG. 13 comprises a schematic screen shot as configured in accordance with various embodiments of the invention;

FIG. 14 comprises a schematic screen shot as configured in accordance with various embodiments of the invention; and

FIG. 15 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, these various embodiments facilitate the development of creative content in a manner that fosters compliance with technical requirements as correspond to an intended end use of that creative content. (As used herein, again, the concept of “development” will be understood to refer to the imagining and/or creation of a creative work as well as actions that are taken to effect the formation, rendering, and/or providing of that creative work in a form suitable for a particular desired end use.) This can comprise providing creative content technical specifications as correspond to a plurality of differing end use vehicles and providing a plurality of creative content development tools that are non-integral with respect to one another and wherein at least some of the creative content development tools are each for use during differing creative content development stages. One then provides a digital processing environment and a creative content development process that uses the digital processing environment along with the plurality of creative content development tools in a substantially integrated manner that makes use of the creative content technical specifications to fully facilitate creative freedom while also simultaneously ensuring compliance with end-use technical specifications.

So configured, correction of developed creative content in order to effect compliance with end-use technical specifications is at least substantially avoided. Instead, the creative content developer interacts with a work environment and a workflow process that informs and/or guides the creative process so as to ensure technical compatibility with respect to the deliverables of that creative process. These benefits may be best attained when used in conjunction with corresponding training for the creative content developer but even a relatively untrained user will tend to produce content that remains ultimately usable in an intended manner without necessitating undue rework to achieve such a result.

By one approach, if desired, this creative content development process can comprise and/or accommodate creating a project workspace with that digital processing environment that comprises, at least in part, a plurality of folders. At least some of these folders can each individually correlate to a different project approval criterion. Access to creative content placed within such folders can be controlled to permit some users while prohibiting others. This, in turn, can aid in ensuring that various persons who play a part in the overall workflow of the creative content development process are both automatically prompted and constrained with respect to how and when to play those parts.

By one approach, if desired, this creative content development process can comprise and/or accommodate providing a plurality of format-defining templates in the digital processing environment where at least some of these templates each correlate to technical requirements as correspond to different intended end users of the creative content. These templates can then serve to receive creative content in the project workspace to thereby inform, guide, and/or constrain the development of that creative content in a manner that remains compatible and consistent with the technical specifications as correspond to such templates.

By another approach, if desired, this creative content development process can also comprise and/or accommodate storing graphic images in the digital processing environment along with completed project deliverables that incorporate such graphic images. Usage information regarding which completed project deliverables incorporate such graphic images can also be similarly stored. So configured, if desired, relevant usage information can then be automatically displayed to a process user when displaying, for example, a given one of the graphic images.

Individual and collectively, such teachings serve to leverage a priori knowledge of end use technical specifications in a manner that tends to support and potentially inspire rather than to frustrate or inhibit the creative process. Creative content developers can know and/or be guided by, in a relatively intuitive and non-challenging way, the technical specifications for end uses that are pertinent to their development projects without needing to spend undue time or effort to obtain or even understand such information. Overall creative content development cycle time can be reduced (sometimes dramatically) with gains being particularly notable as the complexity of the project and/or the number of differing end use vehicles increases.

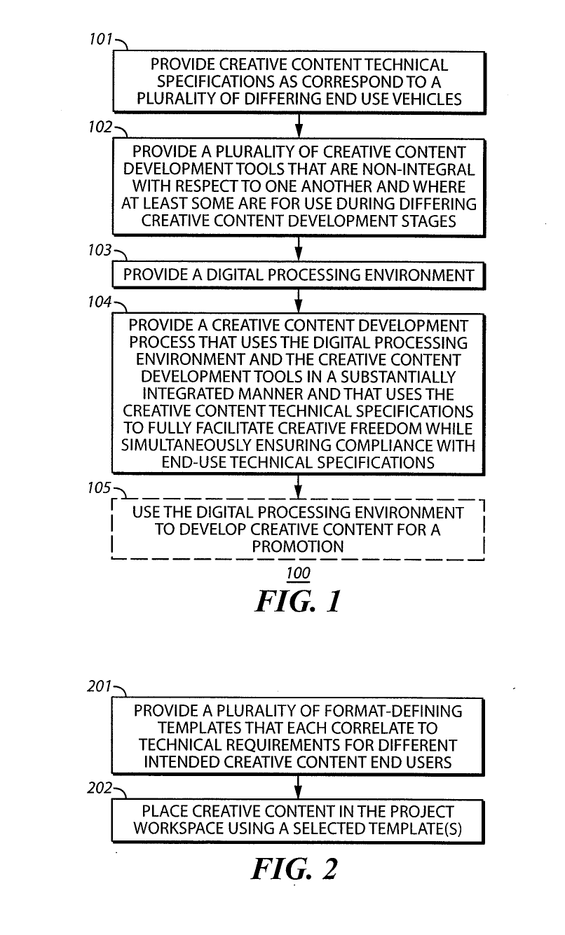

These and other benefits may become clearer upon making a thorough review and study of the following detailed description. Referring now to the drawings, and in particular to FIG. 1, such a process 100 can comprise providing 101 creative content technical specifications as correspond to a plurality of end use vehicles (such as, but not limited to, a plurality of differing public dissemination vehicles (for example, magazines of different sizes, shapes, paper quality, binding technology, utilized printer technology, and so forth, broadcast receivers such as television, radio, and so-called pod casts, Internet-based platforms, radio frequency identification (RFID) devices and so forth)). Some general illustrations of exemplary technical specifications might comprise, for example, size requirements as pertain to text and/or graphic content, image placement technology, ink sets and transfer technologies, and creative content carrier media characteristics, to note but a few.

These technical specifications can vary greatly with respect to the application setting. Examples include, but are not limited to, technical specifications as pertain to various presentation processes (such as printing that relies upon reflected light or active displays that make use of colored light sources to display their respective images), different printing processes (such as screen printing, offset printing, gravure printing, xerographic printing, flexography printing, inkjetting, microdispensing, stamping, and the like), paper weight and variances with respect to ink absorption, in-line web, cutting, folding, collating, die-cutting, stitching, and so forth.

By one approach, these technical specifications will correspond to the presentation of creative content that itself comprises, at least in part, human discemable content. This can comprise, for example, content that is discemable to one of the standard human senses such as sight, sound, touch, or scent. Those skilled in the art will understand and appreciate that these teachings are certainly employable in a setting where the human discemable content comprises promotional content, marketing content, or advertising content (such as product or service advertising, brand awareness development, and so forth).

Ultimately, by one approach, these technical specifications are provided in digital form (though they may first be collected and/or organized in other forms if desired). They may be represented, for example, as an aggregated collection of data. The particular assemblage of data in such a case can also vary as desired. Examples in this regard include, but are not limited to, databases, look-up tables, and so forth. It is also possible to provide this data in other relative form factors. For example, and as described below in more detail, such information can reside, in whole or in part, within corresponding templates.

This process 100 then also provides for the provision 102 of a plurality of creative content development tools. The specific tools will again vary with the specific requirements, needs, and/or opportunities as correspond to a given application setting. In an application setting that presumes print-based end uses, for example, such creative content development tools can comprise (but are not limited to) such tools as a digital graphics image formatting tool, a digital graphics image editing tool, a digital graphics image proofing tool, a digital graphics image preflighting tool, a digital graphics image routing tool, a digital graphics image long-term storage tool, a digital graphics image delivery tool, a digital graphics image approval management tool, and so forth.

Numerous examples of such tools are known in the art and others will no doubt be developed and become available in the future. As the present teachings are not particularly sensitive to the selection of any specific tools in this regard, for the sake of brevity further elaboration will not be provided here regarding such tools (aside from noting that, by one approach, at least one tool from each of the above-noted representative categories can be provided 102 in accordance with this step).

This process 100 then provides for the provision 103 of a digital processing environment. This can assume any of a wide variety of presently known forms. Potentially suitable platforms in this include everything from a single-platform environment to a large multi-node distributed network of supporting platforms. Such architectural choices are well know to those skilled in the art. Therefore, further discussion will not be provided here with regard to the specifics of any such system except as and where appropriate in the text presented below.

This process 100 then provides 104 (via, for example, human guidance and design interaction) a creative content development process (via, for example, corresponding programming and configuring of the digital processing environment) that uses the digital processing environment and the plurality of creative content development tools in a substantially integrated manner. By one approach, for example, this can comprise providing a consistent and common user interface (via, for example, a browser-based front-end) that permits a user to navigate amongst such tools with respect to the development of a given creative content deliverable at each stage of the creative content development process.

This step 104 further provides for using the aforementioned creative content technical specifications to fully facilitate create freedom while also simultaneously ensuring compliance with relevant and applicable end-use technical specifications. By this approach, creative content can be developed in a manner that is compliant with the applicable end-use technical specifications that substantially if not fully avoids a need to make after-the-fact specification-based corrections. That is, this creative content development process also serves to ensure that the development of creative content remains within the bounds of any technical specifications as apply to a given end use purpose from the very beginning of the creative content development and rendering process.

Referring for the moment to FIG. 2, by one approach this can comprise providing 201 in the aforementioned digital processing environment a plurality of format-defining templates, wherein at least some of the format-defining templates each correlate to technical requirements as correspond to different intended end users of the creative content. Such templates will of course reflect if not directly incorporate such technical requirements. In addition, if desired, a plurality of templates can be provided for each such set of technical requirements. This can serve to accommodate, for example, each of the aforementioned creative content development tools. To illustrate, a first template can be provided for use with a particular digital graphics image editing tool (such as, for example, the Photoshop digital graphics image editing tool) to effectively ensure that an image to be employed as a part of a given creative content deliverable is first brought into a corresponding digital workspace in a form that is consistent and compatible with the technical requirements as pertain to an intended end use setting. A second template can then be also provided to ensure, for example, that a different later-selected tool continues to receive, handle, and deliver a work product that will remain compatible with that same intended end use setting.

In some cases it might be possible to fully or partially automate the preparation and formation of such templates. For many application purposes, however, it may be better to pre-configure such templates using, for example, skilled and experienced individuals. Such templates can then be provisioned in a manner to render them readily available as described.

These teachings will then accommodate creation of a deliverable (typically by human personnel) which is then routed within a project workspace (within, for example, the aforementioned digital processing environment) by placing 202 creative content of choice in that project workspace using a selected one (or more) of the format-defining templates. As noted earlier, this can comprise, for example, placing creative content that comprises human discemable promotional content using such a template.

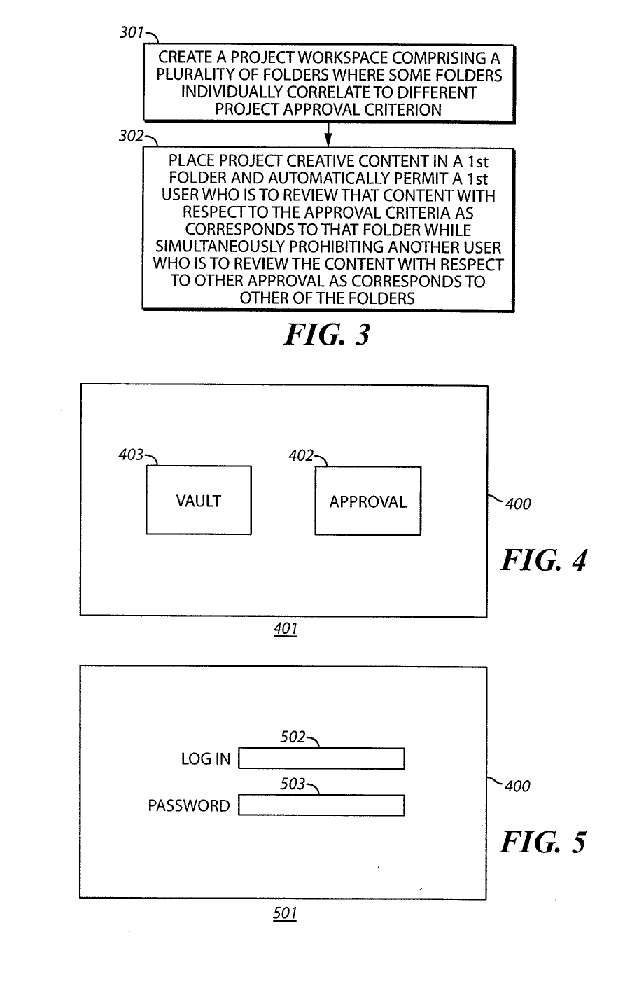

Referring now to FIG. 3, this creative content development process can further comprise, if desired, creating 301 such a project workspace within the digital processing environment wherein the project workspace comprises a plurality of folders. By one approach, at least some of these folders are each individually correlated to a corresponding different project approval criterion (and hence, in many cases, to corresponding persons who are to apply such approval criterion with respect to the corresponding creative content). The specific approval criterion can and will vary considerably with respect to the application setting and the nature of the review itself. To illustrate, different approval criterion will likely be expected for approvals related to creative content management, legal, a corresponding client, and so forth.

The creative content development process can then accept placement 302 of project creative content in a first one of this plurality of folders (such as a folder that corresponds to a first stage of creative content development). This process can then serve to automatically permit a first user (such as a user who is expected and intended to interact with that project creative content during that first stage of creative content development by, for example, reviewing that project creative content with respect to the project approval criterion that corresponds to that first folder) to have access to that folder and hence to that project creative content. At the same time, this process can prohibit one or more other users from also having access to that folder and its contents when those other users are themselves associated with other project approval criteria as corresponds to others of the folders.

So configured, confusion and corresponding errors can be reduced or avoided by effectively ensuring that only appropriate reviews of project creative content can occur at various stages of the development process. (Those skilled in the art will recognize that such “stages” may relate to various technical accomplishments or may relate instead somewhat more arbitrarily to virtual or logical stages that correspond, for example, to budgetary matters, areas of particular managerial responsibility, legal requirements or sensitivities, and so forth as may be relevant, for example, to a particular enterprise.) For example, a legal review may not need to occur until near the conclusion of the development process. In such a case, these teachings can be employed to prohibit the person (or persons) responsible for such a review from accessing the creative content material.

Such an approach can be used in lieu of, or in conjunction with, the aforementioned format-defining template process. As but one example in this regard, when placing the project creative content into the folder as noted above, this can comprise placing the project creative content into the folder using a corresponding format-defining template that corresponds to an intended end use of the creative content.

Such an approval process has numerous benefits in addition to those already alluded. For example, this approach can serve to effectively eliminate the routing of hard copy within an enterprise (or between enterprises) thus saving time and resources. Such an approach can also be readily configured to generate automatic email notifications to alert specific users as to when their attention and/or review is required. For example, such an email can be automatically generated when a project creative content is moved from a first folder as corresponds to a first stage of the development process to a second folder as corresponds to a second stage of the development process to alert, for example, a corresponding manager whose responsibilities now include reviewing that content with respect to a given set of approval criteria.

Such an approach is readily deployed using, if desired, browser-based techniques. To illustrate, as shown in FIG. 4, a given user can use their browser 400 to access a portal page 401 that presents an approval link 402. Selecting this approval link 402 can, in turn, direct that browser 400 to a login page 501 as shown in FIG. 5 that presents a login opportunity 502 and, if desired, a password entry opportunity 503. Such techniques are well known in the art and can serve to restrict and control access to the aforementioned digital workspace and digital processing environment.

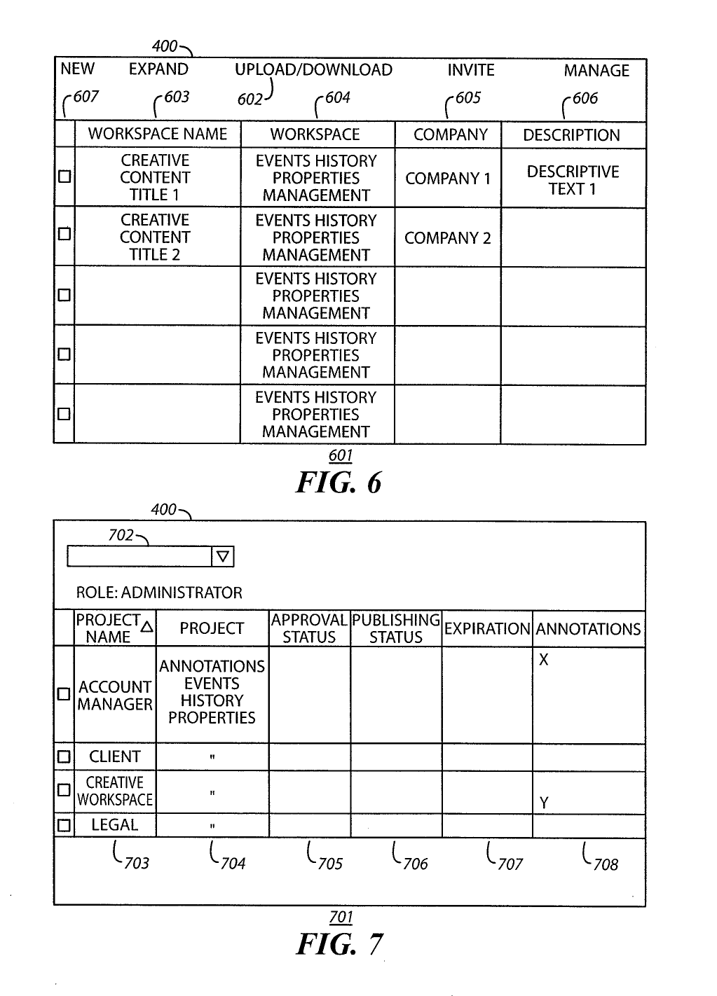

With reference to FIG. 6, following the login process, the user can be directed to a workspace selection page 601. This page 601 can provide some navigation links that are appropriate to these purposes. To illustrate, in this example, the workspace selection page 601 presents a “new” link (to facilitate creation of a new workspace as per these teachings), an “expand” link that expands the data capacity of a workspace an “upload/download” link (to facilitate entering or obtaining selected content, an “invite” link (to permit the user to invite another party to access and view, contribute, access, or otherwise interact or consider the contents of a selected workspace), and a “manage” link, that allows the operator to see who has been invited, to pull (or push) reports, and to otherwise customize the workspace appearance. Other links may of course be provided to meet the needs or to exploit the opportunities posed by a given application setting.

In this illustrative embodiment, for each existing workspace, dedicated fields serve to present a given workspace name 603 (as provided by a workspace creator if desired or as assigned or determined by some other process of choice), a set of workspace links 604, company information 605 (such as the name of the company that is developing the creative content, or for whom the content is being developed, or the like), and a corresponding textual description 606. If desired, the workspace name field 603 can present textual and/or graphic information as corresponds to the corresponding creative content or the like. This workspace name field 603 can also serve to present, if desired, one or more links that will direct the user's browser directly to that workspace.

The workspace links 604 can comprise useful links such as, in this example, an “events history” link, a “properties” link, and a “management” link.

By one approach, each workspace as shown can also have a corresponding selection box 607 as is known in the art. So configured, for example, a user could select a given workspace by selecting the corresponding box and then select a corresponding action such as “upload/download,” “invite,” and the like.

Selection of a given workspace can then lead the user's browser 400 to a corresponding workspace. Such a workspace 701, as illustrated in FIG. 7, can include corresponding project folders as have been described above. By one approach this workspace 701 can include an XXX search capability 702. A drop down selection can be used to navigate between worksheets. (Such a page can also include navigation and/or control options such as “new,” “delete,” “rename,” “upload/download,” “invite to project,” and/or “manage workspace” as desired to facilitate such actions with respect to selected project folders. Such control opportunities are not shown here for the sake of simplicity and clarity.)

As noted above, a folder can be automatically provided for each of a plurality of different review functions. To illustrate, in this illustrative embodiment, a folder has been provided for each of an account manager, the client, a creative workspace function, and legal. Each folder is represented here by a corresponding name field 703, a set of project links 704 (comprising here an “annotations” link, an “events history” link, and a “properties” link), an approval status field 705, a publishing status field 706, an expiration information field 707, and an annotations field 708. Other fields could of course be accommodated, in combination with the noted fields or in lieu thereof, to meet the needs and/or requirements of a given application setting.

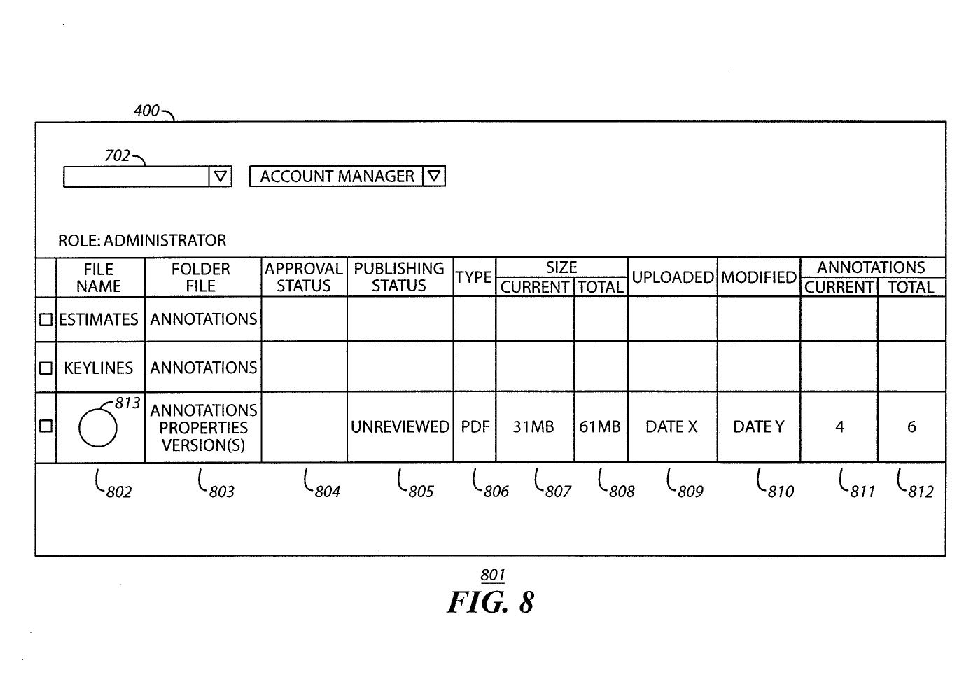

Selection of a given one of these folders can in turn direct the user's browser 400 as shown in FIG. 8 to a project sub-folder page 801. This page 801 presents sub-folder areas that are each comprised of a plurality of fields for information and/or corresponding links. For example, in this illustrative embodiment, each sub-folder area includes a file name field 802 (which again may include text and/or graphics (with the latter being schematically suggested by a circle 813 that represents a thumbnail depiction of content as corresponds to this sub-folder)), a set of folder file links 803, approval status information 804, publishing status information 805, type 806 (referring, for example, to a type of file as characterizes the creative content itself), file size (including current file size 807 and a total file size 808), an uploaded date 809, a modification date 810, and annotation information (including in this example a number of current annotations 811 and total annotations 812).

These sub-folders can be used, for example, for organizational purposes. Such sub-folders can be used, for example, to prevent certain items from simply appearing in an arbitrary and unorganized fashion.

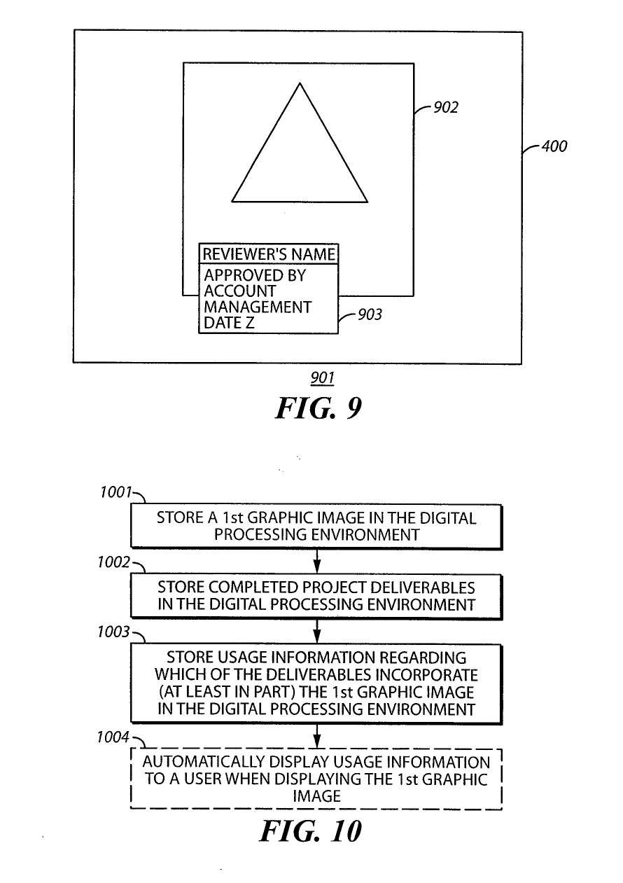

By one approach, and referring now to FIG. 9, a user can select and reach a given corresponding project creative content page 901 which might comprise, for example, a given advertisement 902 comprising text and associated graphics (represented here schematically by a triangle). The purpose of accessing this content can be, for example, to permit the viewer to access the content with respect to a set of approval criteria as noted above. By one approach, if desired, an annotation approach can be employed to facilitate this approval/disapproval process.

To illustrate, as shown, an annotation 903 to the content 902 has been created by the viewer to indicate, in this case, that the creative content meets the applicable standards of review and hence is approved. This same technique could be employed to indicate disapproval. In either case, additional information can be provided as to why the approval or disapproval assessment was made. If desired, other annotation tools (such as drawing tools) can be used to highlight or indicate certain portions of the creative content to which the writer wishes to draw the viewer's attention.

Such annotations can greatly facilitate the overall approval process as comprises a part of the creative content development process. These annotations, for example, can serve to largely or wholly supplant emails, phone calls, and so forth that might ordinarily serve to convey such information. Version control techniques can also be used, if desired, to effectively capture a complete annotation history. The annotation process can also, if desired, be configured and arranged to automatically capture a date and/or time at which the annotation is formed and/or entered.

This creative content development process can also provide for retaining graphic images as comprise, for example, completed or in-process project creative content and corresponding deliverables. By one approach, this can simply comprise an archival approach. If desired, however, and referring now to FIG. 10, additional corresponding information can be stored and/or used and displayed to further contribute to the overall sense of integration for the digital processing environment

Pursuant to the illustrated process, a first graphic image is stored 1001 in the digital processing environment (using, for example, a digital storage environment of choice). Similarly, completed project deliverables are also stored 1002 in the digital processing environment. For purposes of this illustrative example, at least two of these completed project deliverables incorporate, at least in part, the aforementioned first graphic image. For example, the first graphic image might be a picture of a given product that appears in two separate advertisements that comprise the completed project deliverables.

This process also then provides for also storing 1003 usage information regarding which of the completed project deliverables so incorporates the first graphic image. By this illustrated approach this usage information is stored 1003 in the digital processing environment though other approaches might be useful depending upon the application setting. So configured, and if desired, the creative content development process can then further accommodate automatically displaying 1004 at least a part of this usage information to a user when also displaying the first graphic image. This could even include, if desired, automatically (or upon request) displaying at least a portion of the corresponding completed project deliverables as incorporate this graphic image. This usage information can comprise any of a variety of information in this regard, including but not limited to corresponding dates of interest, the identity of the client and/or end use platform or media, technical information (such as file size, image resolution, and so forth) regarding the graphic image, information regarding any legal restrictions as may pertain to the graphic image (such as geographic, temporal, or royalty-based requirements), and so forth.

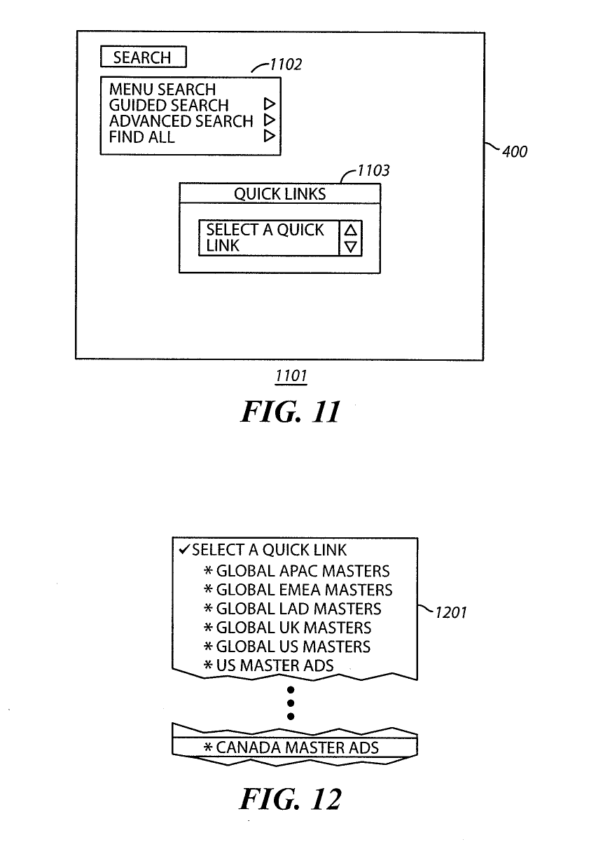

As noted above, this creative content development process can be browser based. With reference again to FIG. 4, the aforementioned portal page 401 can also provide a vault link 403 to permit a user to access such stored graphic images. This vault link 403 could then lead the browser 400 to a vault home page 1101 as schematically illustrated in FIG. 11. This vault home page 1101 can serve, for example, to provide various search mechanisms to assist a user in locating a graphic image of interest. For example, a first search facility 1102 can provide a menu search opportunity, a guided search opportunity, an advanced search opportunity, and/or a “find all” search opportunity. Menu and guided searches are based on preset fields of information. Advanced searches allow for search refinements, i.e. if this and this are found during a search of the site, those assets will be returned.

This vault home page 1101 can also offer a quick link search opportunity 1103. Interacting with this quick link search opportunity 1103 can lead, for example, to a pre-established set of links 1201 in a pop-up menu as generally illustrated in FIG. 12. These links 1201 can in turn represent, for example, general categories by which such graphic images are stored and/or organized. This may represent groupings based upon geography (as is suggested by the view provided), image content, file format, date of creation and/or usage, client, and so forth as desired. Selecting such a quick link can then lead the user's browser 400 to the stored graphic images as correspond to that quick link grouping.

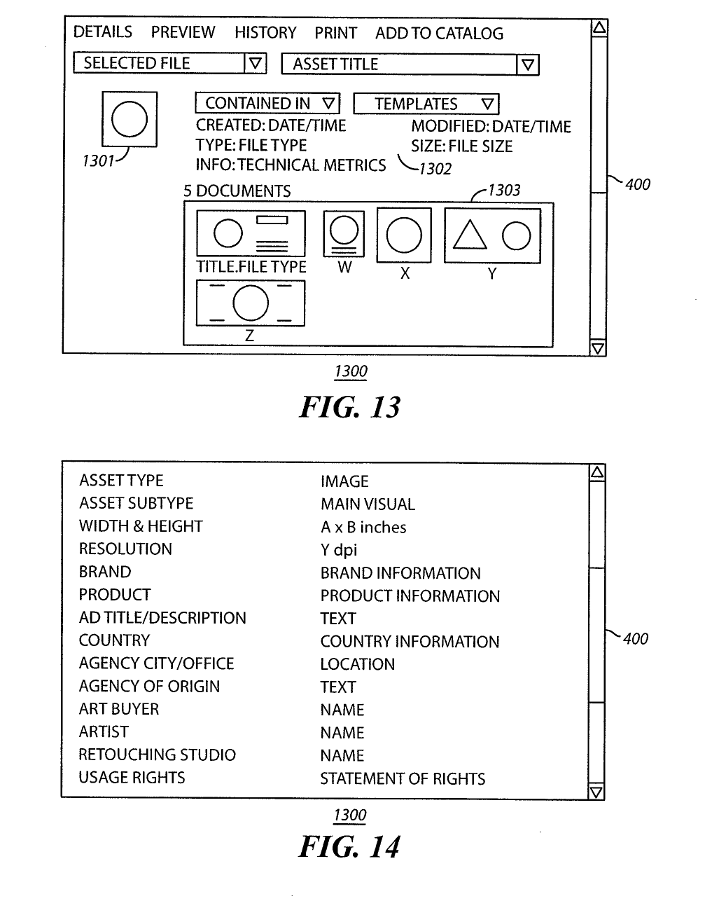

Referring now to FIG. 13, an exemplary illustration of such a search results page 1300 can provide a view of corresponding graphic images. In this illustrative example, the search results comprise a single resultant asset (i.e,. a particular graphic image). These results comprise, here, a thumbnail image 1301 of the graphic image, some brief information 1302 regarding this image, and information 1303 regarding other documents that contain, at least partially, the image in question. After returning an asset and rendering certain details visible, if desired, this capability can be configured and arranged to permit a user to then expand a search of the associated documents whereby those document details become searchable.

By one approach, selecting and/or clicking on the thumbnail image 1301 can serve to access a larger image and/or a download of the corresponding image file. Others possibilities exist in this regard as well. The brief information 1302 can also be as desired. In this illustrative example, this brief information 1302 comprises temporal information regarding the creation and modification of the image, and technical information regarding the image's file type, file size, and other technical metrics of choice (such as, but not limited to, image dimensions (in a scale or metric of choice, resolution, and so forth).

The information 1303 regarding other documents can refer, for example, to completed project deliverables that are also stored within (or accessible to) the digital processing environment and that incorporate, at least in part, the image in question. As shown, this can comprise, for example, thumbnail images of those completed project deliverables (which can include the image itself along with other content as is schematically suggested in the illustration). This information 1303 can also comprise, if desired, a project or file title, file type indicator, and so forth. The thumbnail image, the title information, or both can comprise a link or control mechanism to facilitate bringing forth a larger rendition of the corresponding document, downloading the complete document, accessing other information regarding that document and/or its use, and so forth.

These search results can comprise other information of interest as well if desired. For example, in the example provided, additional informational content appears by scrolling down further on the search results page 1300 to display, for example, additional information as shown in FIG. 4. As suggested by this illustrative example, a wide variety of information can be considered for display in this regard. Examples here include information regarding the asset type, a characterization as to the asset's subtype, specific information regarding height, width, and resolution of the image, information regarding a brand and/or product to which the image might relate, and a title as may also relate to the image. This display can also comprise, if desired, information regarding geographic, agency, art buyer, artist, and retouching studio context as may be applicable to the image.

These search results can also provide, if desired, information regarding usage rights as may apply with respect to the image. Such rights can stem from local laws or regulations or can correspond to contractual obligations as may apply with respect to use of the image.

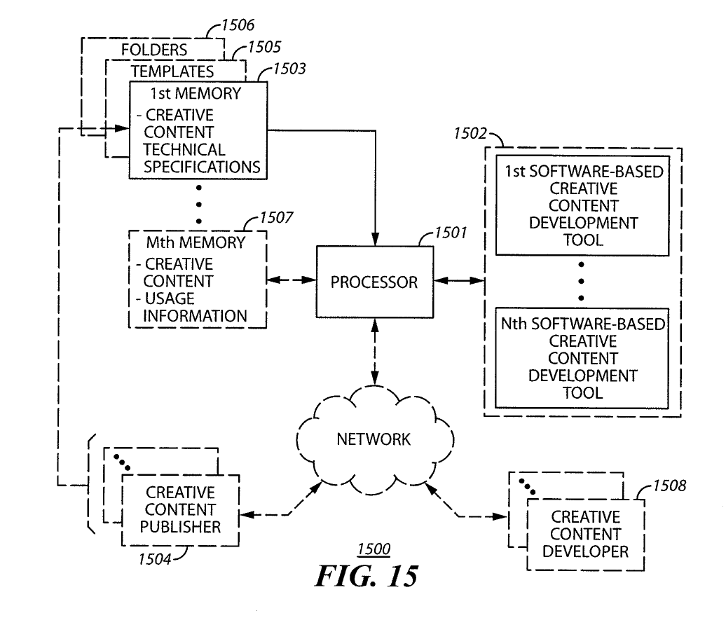

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 15, an illustrative approach to such a digital processing environment 1500 will now be provided.

In this illustrative example, the digital processing environment 1500 comprises a processor 1501 that is configured and arranged (via, for example, corresponding programming as will be understood by those skilled in the art) to effect the teachings set forth herein and in particular to embody and facilitate the aforementioned creative content development process. This processor 1501 in turn operably couples to a plurality of software-based creative content development tools 1502 as described above and as represented here by a first software-based creative content development tool through an Nth software-based creative content development tool. Again, these are the tools that a creative content developer will use to receive, develop, form, edit, and modify their creative deliverables and that others will use to view, critique, edit, analyze, track, and otherwise interact with such creative deliverables.

This process 1501 also operably couples to a first memory 1503 that serves to contain the aforementioned creative content technical specifications as correspond to one or more creative content publishers 1504. Those skilled in the art will understand that, as used herein, “publisher” refers to any of a wide variety of information and content disseminators including print-based, broadcast-based, and browser-based disseminators. In accordance with the teachings set forth above, this first memory can also serve to contain the aforementioned templates 1505 and/or folders 1506 to thereby render such resources available for use as part of the creative content development process.

This processor 1501 can also operably couple, if desired, to another memory 1507 (represented here by an Mth memory) that can store, for example, the aforementioned creative content (including both constituent graphic images, finished work product, and so forth), the aforementioned usage content, and so forth.

By one approach, as when the creative content development process makes use of a browser-based user interface, the processor 1501 can also couple via a network of choice (including but not limited to private local networks as well as extranetworks such as the Internet) to thereby facilitate interaction with the aforementioned creative content publishers 1504 and the creative content developers 1508 (including all entities involved in the creation and/or review and approval process for such creative content projects).

Those skilled in the art will recognize and understand that such a digital processing environment 1500 may be comprised of a plurality of physically distinct elements as is suggested by the illustration shown in FIG. 15. It is also possible, however, to view this illustration as comprising a logical view, in which case one or more of these elements can be enabled and realized via a shared platform or can be further distributed over a greater number of facilitating platforms. It will also be understood that such a shared platform may comprise a wholly or at least partially programmable platform as are known in the art.

So configured, each member of the creative content development process can generally be assured of only needing to attend to their own primary responsibilities in this regard. This creative content development process will function to generally ensure that, from the very beginning of the process, that technical specifications and requirements of content end users will guide and suitably constrain the development of the creative content, albeit in a manner that greatly relieves the creative content developers from an ongoing responsibility to themselves fully comprehend and consciously utilize each such factor in this regard. As shown, these teachings are readily deployed in a manner that tends to ensure that each participant will only engage the process and make their contribution at an appropriate time during the process. These teachings are also readily amendable to the collection, storage, and use of information regarding graphic images that greatly simplifies the task of locating possibly relevant examples by any process participants.

To a large extent, if desired, these benefits are realized to at least some degree even in the absence of much training for the creative content developers. If desired, however, suitable training can of course be provided to such persons. For at least some application settings it may also be useful to provide a production designer. Such a person could be charged, for example, with interacting directly with both relevant managers and creative individuals and teams alike with respect to some, or even all, aspects of digital file preparation via these teachings. Useful skill sets in this regard might include an ability to generate digital file folders, assemble creative requests to specification, create a PostScript (PS) file according to a given intended use or destination, and an ability to create fulfillment files, documents, and the like. Such a role might further entail uploading content for approvals with respect to internal compliance reviews, collecting asset components, monitoring transmission preferences as pertain to particular publishers (again as defined above), and maintaining a creative approval reference library (with details and standards as pertain, for example, to master style requirements or guidelines, logo standards and usage requirements, and so forth. Such a person would likely benefit from having a deep knowledge of page layout and photo software programs such as InDesign, Quark, Photoshop, and Illustrator, to note but a few relevant examples.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method of facilitating creative content development in a manner that fosters compliance with technical requirements as correspond to an intended end use of the creative content, comprising:
providing creative content technical specifications as correspond to a plurality of differing end use vehicles;
providing a plurality of creative content development tools that are non-integral with respect to one another and wherein at least some of the creative content development tools are each for use during differing creative content development stages;
providing a digital processing environment;
providing a creative content development process that uses the digital processing environment and the plurality of creative content development tools in a substantially integrated manner and that makes use of the creative content technical specifications to fully facilitate creative freedom while also simultaneously ensuring compliance with end-use technical specifications such that correction of developed creative content in order to effect compliance with the end-use technical specifications is at least substantially avoided.

2. The method of claim 1 wherein providing creative content technical specifications as correspond to a plurality of differing end use vehicles comprises providing creative content technical specifications as correspond to a plurality of differing public dissemination vehicles.

3. The method of claim 2 wherein providing creative content technical specifications as correspond to a plurality of differing public dissemination vehicles further comprises providing creative content technical specifications as correspond to a plurality of differing presentation processes.

4. The method of claim 3 wherein providing creative content technical specifications as correspond to a plurality of differing presentation processes further comprises providing creative content technical specifications as correspond to a plurality of differing printing processes.

5. The method of claim 1 wherein providing a plurality of creative content development tools comprises providing at least one of:
a digital graphics image formatting tool;
a digital graphics image editing tool;
a digital graphics image proofing tool:
a digital graphics image preflighting tool;
a digital graphics image routing tool;
a digital graphics image long-term storage tool;
a digital graphics image delivery tool;
a digital graphics image approval management tool.

6. The method of claim 5 wherein providing a plurality of creative content development tools comprises providing at least each of:
a digital graphics image formatting tool;
a digital graphics image editing tool;
a digital graphics image proofing tool:
a digital graphics image preflighting tool;
a digital graphics image routing tool;
a digital graphics image long-term storage tool;
a digital graphics image delivery tool;
a digital graphics image approval management tool.

7. The method of claim 1 wherein the creative content comprises, at least in part, human discemable content.

8. The method of claim 7 wherein the human discemable content comprises content corresponding to at least one of promotional content, marketing content, and advertising content.

9. The method claim 1 wherein providing a creative content development process that uses the plurality of creative content development tools in a substantially integrated manner and that makes use of the creative content technical specifications to fully facilitate creative freedom while also simultaneously ensuring compliance with end-use technical specifications comprises:
creating within the digital processing environment a project workspace, wherein the project workspace comprises a plurality of folders, wherein at least some of the plurality of folders are each individually correlated to a corresponding different project approval criterion;
placing project creative content in a first one of the plurality of folders and automatically permitting a first user who is to review the project creative content with respect to the project approval criterion as corresponds to the first one of the plurality of folders to access the project substantive content while simultaneously prohibiting at least one other user who is to review the project creative content with respect to other project approval criterion as corresponds to others of the plurality of folders from accessing the project creative content.

10. The method of claim 9 wherein placing project creative content in a first one of the plurality of folders comprises placing the project creative content in the first one of the plurality of folders using a format-defining template.

11. The method of claim 10 wherein the format-defining template correlates to the technical requirements as correspond to an intended end use of the creative content.

12. The method of claim 1 wherein providing a creative content development process that uses the digital processing environment and the plurality of creative content development tools in a substantially integrated manner and that makes use of the creative content technical specifications to fully facilitate creative freedom while also simultaneously ensuring compliance with end-use technical specifications further comprises:
providing in the digital processing environment a plurality of format-defining templates, wherein at least some of the format-defining templates each correlate to technical requirements as correspond to different intended end users of the creative content;
placing creative content in the project workspace using a selected one of the format-defining templates.

13. The method of claim 12 wherein the creative content comprises human discemable promotional content.

14. The method of claim 1 wherein providing a creative content development process that uses the digital processing environment and the plurality of creative content development tools in a substantially integrated manner and that makes use of the creative content technical specifications to fully facilitate creative freedom while also simultaneously ensuring compliance with end-use technical specifications comprises:
storing a first graphic image in the digital processing environment;
storing completed project deliverables in the digital processing environment wherein at least two of the completed project deliverables incorporate, at least in part, the first graphic image;
storing in the digital processing environment usage information regarding which of the completed project deliverables incorporate, at least in part, the first graphic image.

15. The method of claim 14 further comprising:
automatically displaying at least part of the usage information to a user when displaying the first graphic image.

16. The method of claim 14 wherein automatically displaying at least part of the usage information to a user comprises, at least in part, automatically displaying at least a portion of the completed project deliverables as incorporate, at least in part, the first graphic image.

17. The method of claim 1 further comprising:
using the digital processing environment to develop creative content for at least one of a promotional campaign, a marketing campaign, and an advertising campaign.

18. The method of claim 17 wherein using the digital processing environment to develop creative content for a_promotion comprises using the digital processing environment to develop creative content for at least one of a promotional campaign, a marketing campaign, and an advertising campaign that is intended for dissemination in a plurality of different public dissemination vehicles wherein at least two of the public dissemination vehicles have differing technical specifications to be met by the creative content.

19. The method of claim 1 wherein providing creative content technical specifications comprises, at least in part, providing technical specifications regarding at least one of:
size requirements;
image placement technology;
creative content carrier media characteristics.

20. The method of claim 1 further comprising:
permitting a third party creative content developer to use the digital processing environment to develop creative content for at least one of a promotional campaign, a marketing campaign, and an advertising campaign.

21. The method of claim 20 further comprising:
using the digital processing environment to deliver the creative content developed by the third party creative content developer to a third party creative content publisher.

22. A digital processing apparatus to facilitate creative content development in a manner that fosters compliance with technical requirements as correspond to an intended end use of the creative content, the digital processing apparatus comprising:
a first memory having a plurality of creative content technical specifications as correspond to a plurality of differing end-use vehicles stored therein;
a plurality of software-based creative content development tools that are non-integral with respect to one another and wherein at least some of the creative content development tools are each for use during differing creative content development stages;
a processor that is operably coupled to the first memory and the plurality of software-based creative content development tools and that is configured and arranged to use the plurality of software-based creative content development tools in a substantially integrated manner and that makes use of the creative content technical specifications to fully facilitate creative freedom while also simultaneously ensuring compliance with end-use technical specifications such that correction of developed creative content in order to effect compliance with the end-use technical specifications is at least substantially avoided.

23. The digital processing apparatus of claim 22 wherein the plurality of creative content development tools comprises at least one of:
a digital graphics image formatting tool;
a digital graphics image editing tool;
a digital graphics image proofing tool:
a digital graphics image preflighting tool;
a digital graphics image routing tool;
a digital graphics image long-term storage tool;
a digital graphics image delivery tool;
a digital graphics image approval management tool.

24. The digital processing apparatus of claim 23 wherein the plurality of creative content development tools comprises at least each of:
a digital graphics image formatting tool;
a digital graphics image editing tool;
a digital graphics image proofing tool:
a digital graphics image preflighting tool;
a digital graphics image routing tool;
a digital graphics image long-term storage tool;
a digital graphics image delivery tool;
a digital graphics image approval management tool.

25. The digital processing apparatus of claim 22 wherein the processor is further configured and arranged to:
create within the digital processing environment a project workspace, wherein the project workspace comprises a plurality of folders, wherein at least some of the plurality of folders are each individually correlated to a corresponding different project approval criterion; and
place project creative content in a first one of the plurality of folders and automatically permit a first user who is to review the project creative content with respect to the project approval criterion as corresponds to the first one of the plurality of folders to access the project substantive content while simultaneously prohibiting at least one other user who is to review the project creative content with respect to other project approval criterion as corresponds to others of the plurality of folders from accessing the project creative content.

26. The digital processing apparatus of claim 25 wherein the processor is further configured and arranged to:
provide in the digital processing environment a plurality of format-defining templates, wherein at least some of the format-defining templates each correlate to technical requirements as correspond to different intended end users of the creative content;
create within the digital processing environment a project workspace; and
place creative content in the project workspace using a selected one of the format-defining templates.

27. The digital processing apparatus of claim 26 wherein the processor is further configured and arranged to:
store a first graphic image in the digital storage environment;
store completed project deliverables in the digital storage environment wherein at least two of the completed project deliverables incorporate, at least in part, the first graphic image;
store in the digital storage environment usage information regarding which of the completed project deliverables incorporate, at least in part, the first graphic image.

28. The digital processing apparatus of claim 27 wherein the processor is further configured and arranged to:
automatically display at least part of the usage information to a user when displaying the first graphic image.
